(19) United States
(12) Patent Application Publication
(10) Pub. No.: US 2013/0314508 A1
(43) Pub. Date: Nov. 28, 2013

(54) MANAGEMENT FOR SUPER-REALITY ENTERTAINMENT

(71) Applicant: Takayuki Arima, Rancho Palos Verdes, CA (US)

(72) Inventor: Takayuki Arima, Rancho Palos Verdes, CA (US)

(21) Appl. No.: 13/481,618

(22) Filed: May 25, 2012

(51) Int. Cl. H04N 7/18; H04N 13/02

(52) U.S. Cl. 348/47; 348/143; 348/E13.074; 348/E05.027

(57) ABSTRACT

A system and method are configured to provide super-reality entertainment for a user to realistically experience an activity as if he/she is actually participating in the activity. The method includes preparing multiple activities for each user to select from, providing a participant in each activity with one or more cameras and one or more microphones to capture images and sounds as perceived by the participant during the activity, obtaining information pertaining to the user, including account information and selection of an activity, managing transactions, processing the images and sounds; and transmitting the processed images and sounds to a client terminal of the user who selected the activity.

### BACKGROUND

As new generations of cellular phones, smart phones, laptops, tablets and other wireless communication devices are embedded with increased number of applications, users are increasingly demanding to obtain high quality experiences with the applications particularly in the mobile entertainment arena. Such applications include video viewing, digital media downloading, games, navigations and various others. Recently, reality TV shows and variety shows including games, cooking contests, singing contests and various other entertaining events are becoming popular, indicating the current trend of viewers' preference. However, participants in a reality TV show, for example, are often persuaded to act in specific scripted ways by off-screen producers, with the portrayal of events and speech highly manipulated. Furthermore, viewing of variety shows, sports, documentaries; performing arts, etc. traditionally presents the viewers with a sense of merely observing them as a spectator.

Accordingly, the present invention is directed to a new type of entertainment business that enables viewers to enjoy the vivid images and sounds as perceived by a participant in an actual activity such as adventure, sport, vacationing, competing, etc. Such entertainment can provide the viewer with the realistic sensation filled with on-site and unexpected excitements, thereby opening up a new entertainment paradigm, which is referred to as “super-reality entertainment” hereinafter in this document.

### BRIEF DESCRIPTION OF THE DRAWINGS

FIG. 1 illustrates an example of positions of device 1 and device 2 on a helmet.

FIG. 2 illustrates an example of a system for providing super-reality entertainment services by capturing images and sounds as perceived by a participant in an activity, and transmitting them to a user so that the user can realistically experience the activity as if he/she is participating in the activity.

FIG. 3 is a block diagram illustrating the management system.

FIG. 4 illustrates a method of providing a user with super-reality entertainment by transmitting images and sounds as perceived by a participant in the activity of the user's choice.

### DETAILED DESCRIPTION

A method and system to achieve and manage the “super-reality entertainment” business are described below with reference to accompanying drawings.

A football is an example of an activity in which the players can experience a high degree of excitement, fun and dynamics. The excitement among the players in such a collision sport is apparent owing to the real-time dynamics, involving rushing, kicking, tackling, intercepting, fumbling, etc. Such excitements and sensations felt by the actual players cannot be felt by mere spectators. In a conventional broadcasting system, one or more cameras are provided at fixed locations outside the field where the activity takes place, providing views and sounds as perceived by a mere spectator at the location where the camera is placed. Therefore, enabling users to receive the vivid images and sounds as perceived by the actual participant can provide the excitement and sensation similar to what is felt by the participant himself/herself. Such entertainment may be realized by using a system that is configured to capture images and sounds as perceived by a participant in the activity, and transmit them to a user so that the user can realistically experience the activity as if he/she is participating in the activity.

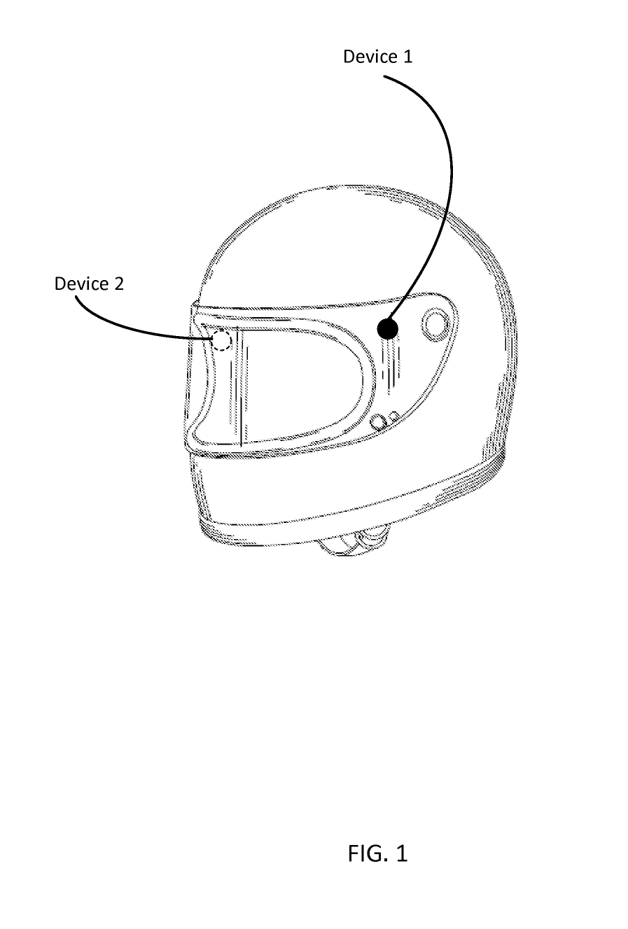

The images and sounds perceived by a participant in the activity can be captured by one or more cameras and one or more microphones provided preferably in the proximity of his/her eyes and ears. FIG. 1 illustrates an example of positions of the cameras and microphones on a helmet. In this example, a device including both a camera and a microphone is used, and two such devices, device 1 and device 2, are attached to both sides of the helmet near the temples of the person who wears the helmet. Two or more cameras can capture the images as seen from two or more perspectives, respectively, which can be processed by using a suitable image processing technique for the viewer to experience the 3D effect. Similarly, two separate microphones may be placed near the ears of the participant, to capture the sounds from two audible perspectives, respectively, which can be processed by using a suitable sound processing technique for the viewer to experience the stereophonic effect. In another example, a microphone may be placed at the back side of the helmet so that the sound from behind can be clearly captured to sense what's going on behind him/her in the activity. In the example of FIG. 1, a device including both a camera and a microphone is used, and two such devices are placed near the participant's temples to capture both the images and sounds at locations as close as possible to the eyes and ears.

The case of playing football is mentioned earlier as an example. Obviously, there are many activities that people wish to participate in, but they normally give up doing so simply because they cannot afford to spend money or time, or they are scared or not healthy enough to try. Enabling a user to receive the vivid images and sounds as perceived by a participant can provide the user with the exciting moments that the user would never experience otherwise. Such entertainment can be made available to users at minimal cost through the use of a TV broadcasting system or an application that is configured to run on cellular phones, smart phones, laptops, tablets or other mobile devices. In most activities, one or more cameras and one or more microphones can be attached to the head gear, helmet, hat, headband or other items that the participant wears or directly to the head or face of the participant during the activity. Such activities that users can enjoy by receiving the captured images and sounds may include, but not limited to, the following:
Mountain climbing by receiving images and sounds as perceived by a mountain climber.
Deep sea exploration by receiving images and sounds as perceived by a deep sea diver.
Spacewalk, moving in zero-gravity, walking on the moon and other space activities by receiving images and sounds as perceived by an astronaut.
Paranormal experience by receiving images and sounds as perceived by a so-called ghost hunter searching a haunted house.
Cave exploration by receiving images and sounds as perceived by a cave explorer.
Vacationing in an exotic location by receiving images and sounds as perceived by a vacationer.
Observing life and people in an oppressed or troubled country by receiving images and sounds as perceived by a reporter.
Sports by receiving images and sounds as perceived by an athlete, such as soccer, football, boxing, fencing, wrestling, karate, taekwondo, tennis and others.
Exploration to the North Pole or the South Pole by receiving images and sounds as perceived by an explorer.
Firefighting by receiving images and sounds as perceived by a firefighter.
Medical operation by receiving images and sounds as perceived by a surgeon.
Cooking by receiving images and sounds as perceived by a chef or an amateur.
Performing on stage by receiving images and sounds as perceived by a singer or an actor on stage.
Cleaning and processing garbage by receiving images and sounds as perceived by a cleaning crew member.
Encountering wild animals in Africa by receiving images and sounds as perceived by a traveler.
Crime scene investigation by receiving images and sounds as perceived by an investigator or a police officer.
Bad weather experience by receiving images and sounds as perceived by a tornado chaser.
Hot air balloon ride by receiving images and sounds as perceived by a rider.
Bungee jumping by receiving images and sounds as perceived by a jumper.
Car or motorcycle racing by receiving images and sounds as perceived by a racer.
Horse racing by receiving images and sounds as perceived by a jockey.

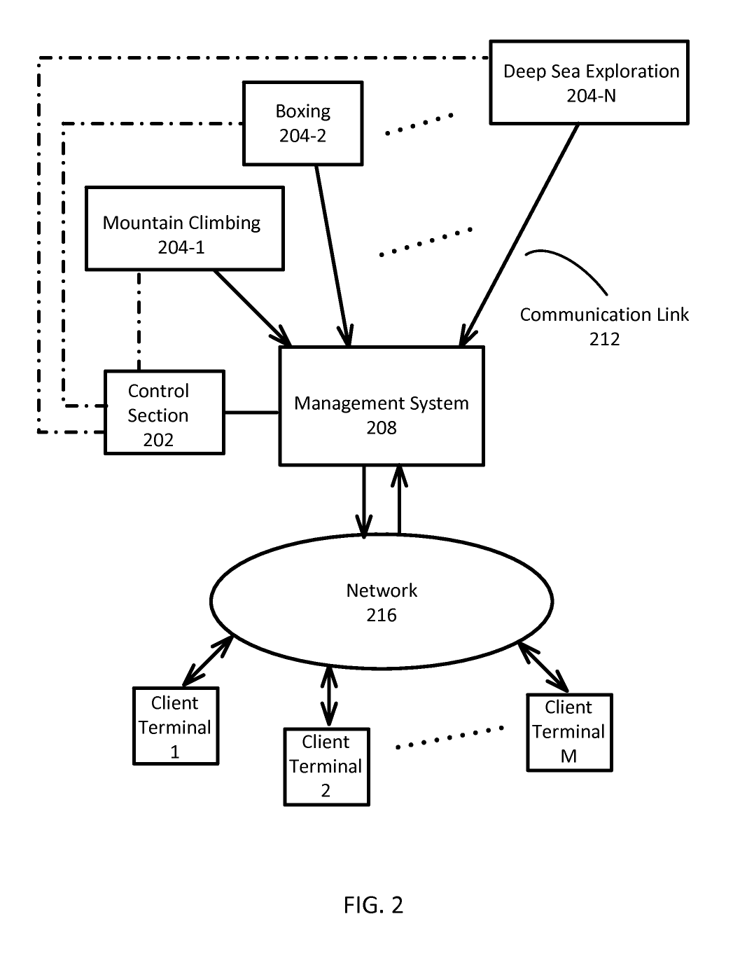

FIG. 2 illustrates an example of a system for providing super-reality entertainment services by capturing images and sounds as perceived by a participant in an activity, and transmitting them to a user so that the user can realistically experience the activity as if he/she is participating in the activity. A control section 202 represents a commanding entity, such as an organization, a company, a team or a person, who plans and manages the operation of the entertainment business. For example, a number of activities of interest can be planned and prepared by the control section 202, as indicated by dashed-dotted lines in FIG. 2. The control section 202 may decide on the types of activities to pursue, schedule the activity to take place at a certain time and date, select a place that is proper for pursuing the activity, etc. Furthermore, the control section 202 may hire or contract with people who can actually participate in the activities, for example, an experienced mountain climber for mountain climbing 204-1, a professional boxer for boxing 204-2, . . . and a diver with a biology background for deep sea exploration 204-N. The control section 202 may be further configured to pay for expenses to pursue the activities, such as travel expenses and equipment purchase/rental fees, in addition to paying wages to the participants and other supporting staff. Once the activity is planned, the control section 202 provides the participant with one or more cameras and one or more microphones to be attached to his/her head gear, helmet, hat, headband or other item that the participant wears or directly to the head or face of the participant. Thereafter, the planned activity is conducted at a predetermined time and place.

The number of cameras and the number of microphones provided with a participant may vary according to predetermined needs for image and sound reception. As mentioned earlier, a device including both a camera and a microphone, or other sensing devices may be used alternatively to using separate cameras and microphones. The vivid images and sounds captured by the participant in each activity are transmitted to a management system 208 through a communication link 212. The communication link 212 may represent a signal channel based on wireless communication protocols, satellite transmission protocols, or any other signal communication schemes.

The management system 208 may be located in a server and is configured to receive and process the signals including the images and sounds transmitted from the participants. The management system 208 is further configured to communicate with client terminals, 1, 2 . . . and M through a network 216. The network may include one or more of the Internet, TV broadcasting network, satellite communication network, local area network (LAN), wide area network (WAN), personal area network (PAN), and other communication networks. The client terminals may include cellular phones, smart phones, iPad®, tablets and other mobile devices or TV sets. Each client terminal has a screen and a speaker to reproduce the images and sounds that have been transmitted from a participant and processed by the management system 208. The transmission and playing back of the images and sounds may be handled by a TV broadcasting system or an application that is configured to run on cellular phones, smart phones, laptops, tablets or other mobile devices. The control section 202 controls various functions that the management system 208 performs through an algorithm associated with a CPU, for example.

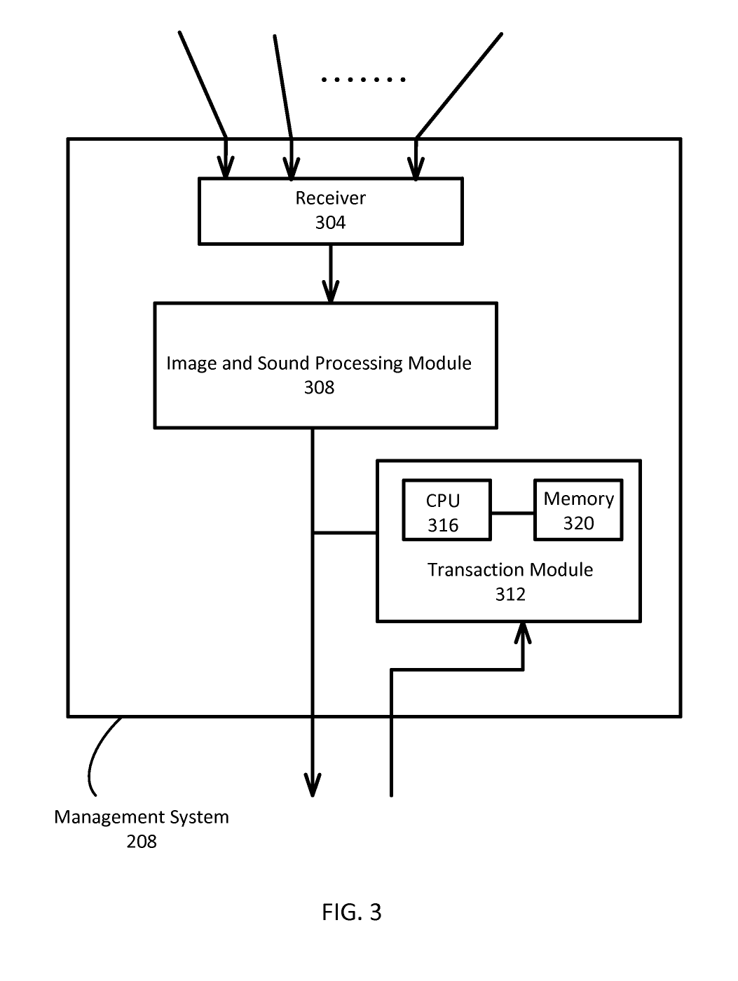

FIG. 3 is a block diagram illustrating the management system 208. The signals transmitted from the participants are received by a receiver 304. The receiver 304 may include an antenna and other RF components for analog-to-digital conversion, digital-to-analog conversion, power amplification, digital signal processing, etc. to receive the signals. Any receiver technologies known to those skilled in the art can be utilized for the implementation of the receiver 304 as appropriate. The received signals are sent to an image and sound processing module 308, where the images and sounds are processed and prepared for transmission to the client terminals. For example, the images with different perspectives captured by two or more cameras of the participant may be processed for the user to experience the 3D effect. In another example, blurred or rapidly fluctuating images due to camera shaking may be corrected to be viewed without causing discomfort to the user. In yet another example, a loud noise, such as the roaring sound of a vehicle, may be reduced to a comfort level. In yet another example, the sounds from different audible perspectives captured by two or more microphones of the participant may be processed for the user to experience the stereophonic effect. Any image and sound processing technologies known to those skilled in the art can be utilized for the implementation of the image and sound processing module 308 as appropriate. The management system 208 further includes a transaction module 312, which may include a CPU 316 for controlling algorithms, electronic components and modules, information flow, etc. as well as a memory 320 for storing predetermined data and/or acquired date during the operation such as information associated with users and the processed images and sounds. The data can be updated as needed. The images and sounds received from the participants may be stored in the memory 320 after the processing at the image and sound processing module 312, and released real-time or later for showing or downloading at the time the user specifies. The real-time showing can be arranged, but may experience a minor time lag due to the image and sound processing at the image and sound processing module 312.

The transaction module 312 is configured to receive input information that the users input at the respective client terminals and transmitted through the network 216. A prompt page may be configured for the users to input necessary information. The input information pertains to the user, including an ID of the user, his/her choice of the payment method (credit card, PayPal®, money order, etc.), his/her credit card number if the credit card payment is chosen, and other account information, as well as the activity of his/her choice. In addition to such information necessary for viewing, the user may be asked which activity is his/her favorite so that the schedule of the particular activity may be sent to the user. A personal preference, such as his/her favorite participant, may also be added. The user makes the payment to view the real-time or later showing or to download the stored video of the activity he/she chooses. In this way, the user can share the common experience with the actual participant through the images and sounds captured by the cameras and microphones placed in the proximity of the participant's eyes and ears. The information from the user may be stored in the memory 320 and updated when the user changes his/her account information, activity of choice, favorite participant, favorite activity, or any other information pertaining to the user.

Upcoming activities and schedules may be sent in advance by the transaction module 312 to the client terminals. The users may request to receive such information via emails. Alternatively, such information can be broadcast via audio/visual media to the client terminals. The schedule may list the names or IDs of the participants participating in upcoming activities so that the user can select the activity that his/her favorite participant is scheduled to pursue. The fee for real-time viewing, later viewing or downloading may be a flat rate. Prior to the viewing or downloading, the input information including the account information and the choice of an activity is obtained by the transaction module 312 from the user as inputted at the client terminal. Payment can be made using the payment method that the user specified as part of the account information. The transaction module 312 is configured to send the processed images and sounds, corresponding to the selected activity, to the client terminal of the user who selected the particular activity.

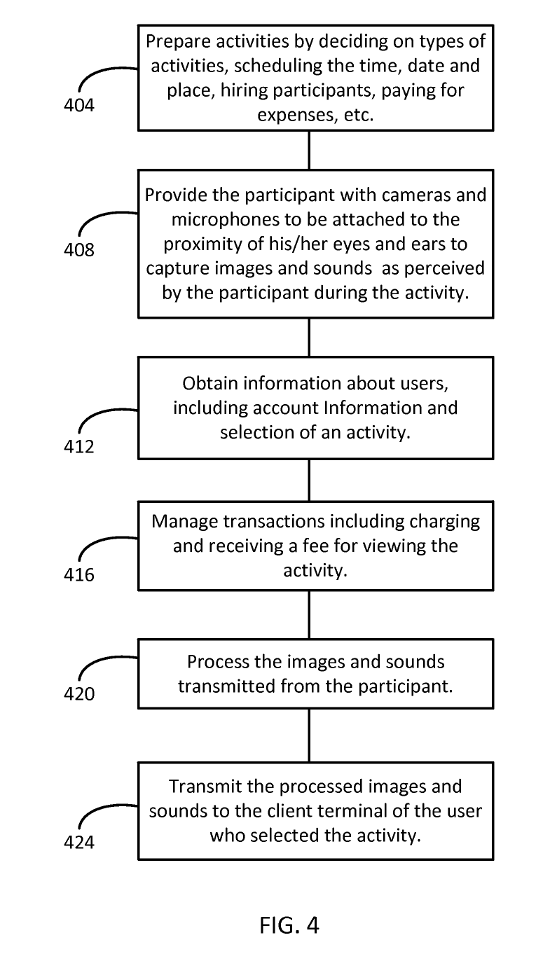

FIG. 4 illustrates a method of providing a user with super-reality entertainment by transmitting images and sounds as perceived by a participant in the activity of the user's choice. Multiple activities can be planned; and a large number of users can be entertained through the present system of FIG. 2 including the control section, 202, management system 208, network 216 and multiple client terminals that the users use, respectively. The order of steps in the flow charts illustrated in this document may not have to be the order that is shown. Some steps can be interchanged or sequenced differently depending on efficiency of operations, convenience of applications or any other scenarios. In step 404, various activities are prepared, for example, by deciding on the types of activities to pursue, scheduling the activity to take place at a certain time and date, selecting a place that is proper for pursuing the activity, etc. Furthermore, the preparation may include hiring or contracting with people who can actually participate in the activities, for example, an experienced mountain climber for mountain climbing 204-1, a professional boxer for boxing 204-2, . . . and a diver with a biology background for deep sea exploration 204-N, as illustrated in FIG. 2. The preparation may further include paying for expenses to pursue the activities, such as travel expenses and equipment purchase/rental fees, in addition to paying wages to the participants and other supporting staff. In step 408, each participant is provided with one or more cameras and one or more microphones that can be attached to the proximity of his/her eyes and ears so as to capture images and sounds as perceived by the participant during the activity. These devices may be attached to the face or head of the participant directly, or to a head gear, helmet, hat, headband or other item that the participant wears. In step 412, information pertaining to users is obtained, via, for example, a prompt page for inputting the information on a screen of the client terminal that the user is using. The input information includes the activity selected by the user as well as account information, such as an ID of the user, his/her choice of the payment method (credit card, PayPal®, money order, etc.), his/her credit card number if the credit card payment is chosen, and the like. The input information may further include the user's favorite activity, favorite participant, and other personalized information. Such information about each user may be stored in the memory 320 in FIG. 3 of the management system 208 for reference. In step 416, the transaction is managed, including charging and receiving a fee for viewing or downloading the activity video. The fee can be paid through the payment method that the user specified. In step 420, the images and sounds captured by the devices attached to the participant are processed by using the image and sound processing module 308 in FIG. 3. For example, the images with different perspectives captured by two or more cameras of the participant may be processed for the user to experience the 3D effect. In another example, blurred or rapidly fluctuating images due to camera shaking may be corrected to be viewed without causing discomfort to the user. In yet another example, a loud noise, such as the roaring sound of a vehicle, may be reduced to a comfort level. In yet another example, the sounds from different audible perspectives captured by two or more microphones of the participant may be processed for the user to experience the stereophonic effect. In step 424, the processed images and sounds are sent to the client terminal of the user who selected the activity. The images and sounds may be stored in the memory 320 after the processing at the image and sound processing module 312, and released real-time or later for showing or downloading at the time the user specifies. The real-time showing can be arranged, but may experience a minor time lag due to the image and sound processing at the image and sound processing module 312

While this document contains many specifics, these should not be construed as limitations on the scope of an invention or of what may be claimed, but rather as descriptions of features specific to particular embodiments of the invention. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be exercised from the combination, and the claimed combination may be directed to a subcombination or a variation of a subcombination.

What is claimed is:

1. A method of providing entertainment for each of a plurality of users to realistically experience an activity, the method comprising:
preparing a plurality of activities for each user to select from;
providing a participant in each activity with one or more cameras and one or more microphones to capture images and sounds as perceived by the participant during the activity;
obtaining information pertaining to the user, including account information and selection of an activity;
managing transactions;
processing the images and sounds; and
transmitting the processed images and sounds captured as perceived by the participant during the activity to a client terminal of the user who selected the activity.

2. The method of claim 1, wherein
the managing transactions comprises:
charging the user a fee to receive the processed images and sounds of the selected activity; and
receiving the fee based on the account information obtained from the user.

3. The method of claim 1, wherein
the preparing the plurality of activities comprises:
deciding on types of the activities;
scheduling the plurality of activities; and
hiring people who participate in the plurality of activities.

4. The method of claim 3, wherein
the preparing further comprises:
paying for expenses; and
paying wages to the hired people.

5. The method of claim 1, wherein
the one or more cameras and the one or more microphones are attached to a proximity of the participant's eyes and ears.

6. The method of claim 5, wherein
the one or more cameras and the one or more microphones are attached to a face or head of the participant, or to a head gear, helmet, hat, headband, or other item that the participant wears.

7. The method of claim 1, wherein
the processing images and sounds comprises correcting blurred or rapidly fluctuating images due to camera shaking.

8. The method of claim 1, wherein
the processing images and sounds comprises processing sounds from different audible perspectives captured by two or more microphones to generate a stereophonic effect.

9. The method of claim 1, wherein
the processing images and sounds comprises processing images with different perspectives captured by two or more cameras to generate a three-dimensional effect.

10. The method of claim 1, wherein
the transmitting the processed images and sounds comprises using a TV broadcasting system or an application that is configured to run on cellular phones, smart phones, laptops, tablets or other mobile devices.

11. The method of claim 1, further comprising:
storing the processed images and sounds.

12. The method of claim 1, wherein
the transmitting the processed images and sounds comprises releasing real-time the processed images and sounds or releasing at a time the user specifies the processed images and sounds that were stored.

13. A system for providing entertainment for each of a plurality of users to realistically experience an activity, the system comprising:
a control section configured to prepare a plurality of activities for each user to select from, hire a plurality of participants to participate in the plurality of activities, and provide one or more cameras and one or more microphones with a participant of each activity to capture images and sounds as perceived by the participant during the activity;
a receiver for receiving the images and sounds;
an image and sound processing module for processing the images and sounds; and
a transaction module configured to obtain information pertaining to each user, including account information and selection of an activity, and transmit the processed images and sounds captured as perceived by the participant during the activity to a client terminal of the user who selected the activity.

14. The system of claim 13, wherein
the transaction module is further configured to perform operations comprising:
charging the user a fee to receive the processed images and sounds of the selected activity; and
receiving the fee based on the account information obtained from the user.

15. The system of claim 13, wherein
the transaction module comprises a memory to store the processed images and sounds and the information pertaining to each user.

16. The system of claim 13, wherein
the transaction module is coupled to a plurality of client terminals through a network including one or more of Internet, a TV broadcasting network, a satellite communication network, a local area network (LAN), a wide area network (WAN), a personal area network (PAN), and other communication networks.

17. The system of claim 13, wherein
the client terminal is a TV, a cellular phone, a smart phone, a laptop, a tablet or other mobile device.

18. The system of claim 13, wherein
the transaction module is configured to transmit, real-time or at a time specified by the user, the processed images and sounds to the client terminal of the user.

19. The system of claim 13, wherein
the image and sound processing module is configured to perform one or more of operations comprising:
correcting blurred or rapidly fluctuating images due to camera shaking;
reducing a loud noise to a comfort level;
processing sounds from different audible perspectives captured by two or more microphones to generate a stereophonic effect; and
processing images with different perspectives captured by two or more cameras to generate a three-dimensional effect.
